(19) United States
(12) Patent Application Publication
(10) Pub. No.: US 2020/0094462 A1
(43) Pub. Date: Mar. 26, 2020

(54) COMPOSITE ANNULAR SEAL AND METHOD OF MAKING THE SAME

(71) Applicant: Parker-Hannifin Corporation, Cleveland, OH (US)

(72) Inventors: Jacob BALLARD, Lexington, KY (US); Aaron HOWARD, Georgetown, KY (US)

(21) Appl. No.: 16/545,344

(22) Filed: Aug. 20, 2019

Related U.S. Application Data
(60) Provisional application No. 62/733,757, filed on Sep. 20, 2018.

(51) Int. Cl. B29C 48/00; B29C 48/21

(52) U.S. Cl. CPC B29C 48/0021; B29K 2027/12; B29C 48/21

(57) ABSTRACT

A method of manufacturing a composite annular seal for a semiconductor process chamber is provided. The method includes extruding a first elastomeric material in uncured form to form a cord of uncured first elastomeric material and extruding, via crosshead extrusion, a second elastomeric material in uncured form onto an outer surface of the cord of uncured first elastomeric material to form an uncured radially layered cord. The uncured radially layered cord includes an inner core of the first elastomeric material and an outer layer of the second elastomeric material. The second elastomeric material is different than the first elastomeric material. The method also includes co-curing the first and second elastomeric material of the uncured radially layered cord to form a cured radially layered cord. The method also includes splicing, via hot vulcanization, a first and second end of the cured radially layered cord to form the composite annular seal.

This application claims priority to U.S. Provisional Application No. 62/733,757 filed Sep. 20, 2018, which is incorporated herein by reference.

### FIELD OF INVENTION

The present invention relates generally to seals, and more particularly to a composite annular seal having enhanced thermal and chemical resistance for use in a semiconductor process chamber.

### BACKGROUND OF THE INVENTION

A semiconductor process chamber commonly includes a container, a lid, and a seal that seals an interface between the container and the lid. For example, a continuous annular thermosetting or thermoplastic rubber seal may be used. A common configuration of an annular seal is an O-ring seal having a circular circumference and a circular cross-section, however other annular seals may have a non-circular circumference and/or a non-circular cross-section.

Many semiconductor manufacturing methods now use processing chambers to create ultra-high-vacuum (UHV—pressures lower than about 10⁻⁷ pascal and/or 10⁻⁹ torr) and/or ultra-high-purity (UHP—total maximum contaminant level of 10 ppm) environments. Due to the aggressive chemical and thermal nature of plasma or other process gases in these processing chambers, large annular seals made from materials having outstanding chemical and temperature resistance are desired. For example, homogenous annular seals made from perfluoroelastomers (FFKM), conventionally manufactured by compression or injection molding, may be used to seal semiconductor process chambers under these conditions. Homogenous FFKM seals, however, are typically quite expensive and may require replacement on a regular basis as they get etched by the process gases during use, resulting in very high cost to the semiconductor manufacturer. Moreover, homogenous FFKM seals are somewhat lacking in the level of resilience that is desired for semiconductor sealing applications.

### SUMMARY OF THE INVENTION

Provided herein is a lower cost process chamber seal for semiconductor applications that is highly resistant to aggressive chemical and thermal conditions and a method of manufacturing the same. A composite annular seal having an inner core layer including a first, lower cost elastomeric material and an outer sleeve layer including a second, different elastomeric material is, therefore, provided. The composite annular seal of the present invention may be manufactured by sequential or crosshead co-extrusion of the first elastomeric material and the second elastomeric material to form a radially layered cord having the inner core layer and the outer sleeve layer. After the first elastomeric material of the inner core layer and the second elastomeric material of the outer sleeve layer are co-extruded to form a radially layered cord, the materials are co-cured and crosslinked together at their interface. The co-extruded radially layered cord is then spliced at its ends to form the composite annular seal. The splicing may be facilitated using a small amount of uncured second elastomeric material and curing the small amount of second elastomeric material to secure the ends together and form the composite annular seal. The first elastomeric material may be a fluoroelastomer (FKM) and the second elastomeric material may be a perfluoroelastomer (FFKM).

An aspect of the invention, therefore, is a method of manufacturing a composite annular seal for a semiconductor process chamber. The method includes extruding a first elastomeric material in uncured form to form a cord of uncured first elastomeric material. The method also includes extruding, via crosshead extrusion, a second elastomeric material in uncured form onto an outer surface of the cord of uncured first elastomeric material to form an uncured radially layered cord. The uncured radially layered cord includes an inner core made of the first elastomeric material and an outer layer made of the second elastomeric material. The second elastomeric material is different than the first elastomeric material. The method also includes co-curing the first elastomeric material and the second elastomeric material of the uncured radially layered cord to form a cured radially layered cord. The method also includes splicing a first end of the cured radially layered cord with a second end of the cured radially layered cord to form the composite annular seal.

In an embodiment, the splicing comprises splicing via hot vulcanization.

In an embodiment, the second elastomeric material is more thermally and chemically resistant than the first elastomeric material.

In another embodiment, the first elastomeric material comprises a fluoroelastomer.

In another embodiment, the second elastomeric material comprises a perfluoroelastomer.

In another embodiment, the co-curing further includes inserting the uncured radially layered cord into a protective sacrificial sleeve to form a curing assembly. In this embodiment, the method then includes heating the curing assembly in an inert atmosphere autoclave for a time and temperature appropriate to sufficiently cure the first elastomeric material and the second elastomeric material of the uncured radially layered cord and crosslink the first elastomeric material and the second elastomeric material at an interface. The method then includes removing the protective sacrificial sleeve.

In a further embodiment, the protective sacrificial sleeve comprises a pre-cured elastomeric material.

In another embodiment, the uncured cord of first elastomeric material has a cross-sectional diameter greater than a cross-sectional diameter of the inner core of the uncured radially layered cord.

In another embodiment, the composite annular seal has a cross-sectional diameter ranging from 1.00 millimeters to 10.00 millimeters.

In another embodiment, the composite annular seal has a cross-sectional diameter of 5.33 millimeters.

In another embodiment, the composite annular seal has an interior diameter ranging from 152.4 millimeters to 457.2 millimeters.

In another embodiment, a composite annular seal manufactured by the method of this aspect of the invention is provided.

In another aspect of the invention, a method of manufacturing a composite annular seal for a semiconductor process chamber is provided. The method according to this aspect includes extruding a first elastomeric material in uncured form to form a cord of uncured first elastomeric material, wherein the first elastomeric material comprises a fluoroelastomer. The method also includes extruding, via crosshead extrusion, a second elastomeric material in uncured form onto an outer surface of the cord of uncured first elastomeric material to form the uncured radially layered cord. The uncured radially layered cord includes the inner core made of the first elastomeric material and an outer layer made of the second elastomeric material. The extruding reduces the diameter of the cord of uncured first elastomeric material by 0.127 millimeter to 0.381 millimeter. The second elastomeric material includes a perfluoroelastomer that is more thermally and chemically resistant than the fluoroelastomer of the first elastomeric material. The method according to this aspect of the invention also includes co-curing the first elastomeric material and the second elastomeric material of the uncured radially layered cord to form a cured radially layered cord. The co-curing includes inserting the uncured radially layered cord into a pre-cured protective sacrificial sleeve to form a curing assembly and heating the curing assembly in an inert atmosphere autoclave for a time and temperature appropriate to sufficiently cure the first elastomeric material and the second elastomeric material of the uncured radially layered cord and crosslink the first elastomeric material and the second elastomeric material at an interface. The method also includes removing the protective sacrificial sleeve and splicing a first end of the cured radially layered cord with a second end of the cured radially layered cord to form the composite annular seal. The composite annular seal has a cross-sectional diameter of 5.33 millimeters and an interior diameter ranging from 152.4 millimeters to 457.2 millimeters.

In an embodiment, the splicing comprises splicing via hot vulcanization.

In an embodiment, a composite annular seal manufactured by the method according to this aspect of the invention is provided.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram of an axial cross-sectional perspective view of a composite annular seal according to an aspect of the present invention.

FIG. 2 is a schematic diagram of a longitudinal cross-section of a length of a radially layered cord according to an aspect of the present invention.

FIG. 3 is a schematic diagram of the longitudinal cross-section of the length of the radially layered cord of FIG. 3 in a protective sacrificial sleeve.

FIG. 4 is a schematic diagram of a radial cross-section of the composite annular seal of FIG. 1.

### DETAILED DESCRIPTION

Embodiments of the present invention will now be described with reference to the drawings, wherein like reference numerals are used to refer to like elements throughout. It will be understood that the figures are not necessarily to scale. These drawings and this description are not to be construed as being limited to the particular illustrative forms of the invention disclosed. It will become apparent to those skilled in the art that various modifications of the embodiments herein can be made without departing from the spirit or scope of the invention.

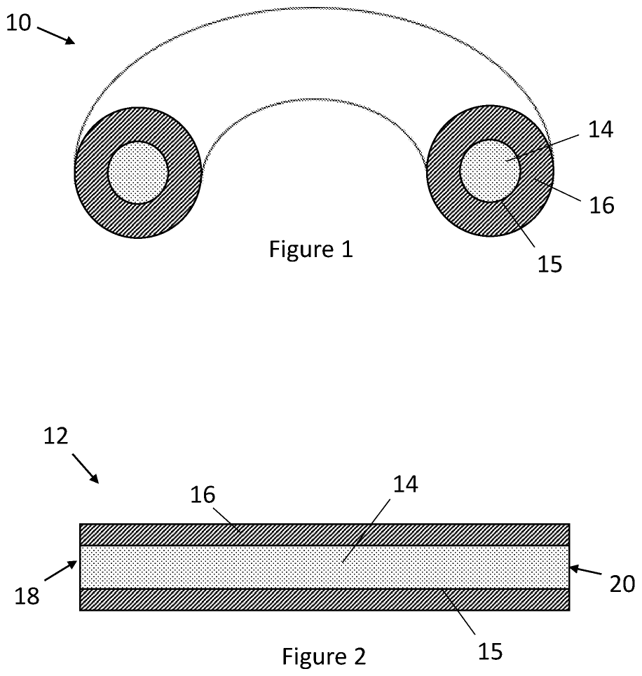

With reference to FIG. 1, a composite annular seal 10 for sealing a process chamber in a semiconductor is depicted in an axial cross-sectional perspective view.

The composite annular seal 10 may be, for example, an O-ring seal. The composite annular seal 10 includes a radially innermost core layer 14 (hereinafter referred to as inner core 14) and a radially outermost sleeve layer 16 (hereinafter referred to as outer layer 16). The inner core 14 includes a first elastomeric material and the outer layer 16 includes a second elastomeric material that is different than the first elastomeric material. The first and second elastomeric materials may be selected specifically for compatibility with the plasma or other process gas in the process chamber that the composite annular seal 10 is intended to seal. Suitable materials, therefore, may include natural rubbers, as well as thermoplastic, i.e., melt-processible, or thermosetting, i.e., vulcanizable, synthetic rubbers. Examples of rubbers and elastomeric materials may include natural polyisoprene (NR), synthetic polyisoprene (IR), polybutadiene (BR), chloroprene rubber (CR), butyl rubber, styrene-butadiene rubber (SBR), nitrile rubber (NBR), hydrogenated nitrile butadiene rubber (HNBR), ethylene-propylene rubber (EPM), ethylene-propylene-diene rubber (EPDM), ethylene acrylic rubber (AEM), polyacrylic rubber (ACM, ABR), silicone rubber, fluorosilicones, fluoroelastomers (FKM), perfluoroelastomers (FFKM), polyether block amides (PEBA), chlorosulfonated polyethylene, ethylene-vinyl acetate (EVA), and/or blends of two or more thereof.

The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

The second elastomeric material of the outer layer 16 may be more thermally and chemically resistant than the first elastomeric material of the inner core 14. The second elastomeric material of the outer layer 16 may include, therefore, any highly thermally and chemically resistant elastomer, such as for example FFKM. Accordingly, in an embodiment, the first elastomeric material of the inner core 14 includes FKM or any other conventional elastomeric material, and the second elastomeric material of the outer layer 16 includes FFKM or any other elastomeric material that is more thermally and chemically resistant than conventional FKM. The composite annular seal 10, therefore, can be constructed to achieve UHV and/or UHP levels without compromising on cleanliness, and can efficiently be used in UHV and/or UHP processing chambers with improved plasma, or other process gas resistance.

Generally, the composite annular seal 10 may be manufactured by sequential or crosshead co-extrusion of the first elastomeric material of the inner core 14 and the second elastomeric material of the outer layer 16 to create a length of a radially layered cord 12, as depicted in longitudinal cross-section in FIG. 2. More specifically, in an embodiment, the first elastomeric material of the inner core 14, in uncured form, may be extruded first to form a cord of uncured first elastomeric material. The cord of uncured first elastomeric material is essentially, therefore, the inner core 14 of the radially layered cord 12, without the outer layer 16 on its outer surface. The cord of uncured first elastomeric material may have a cross-sectional diameter of 0.127 millimeter to 0.381 millimeter greater than the final cross-sectional diameter of the inner core 14 of the radially layered cord 12. In this embodiment, the second elastomeric material of the outer layer 16, in uncured form, may then be extruded via crosshead extrusion onto an outer surface of the cord of uncured first elastomeric material to form an uncured radially layered cord 12. The outer layer 16 is formed by applying the uncured second elastomeric material of the outer layer 16 onto the surface of the previously produced cord of uncured first elastomeric material. The process of applying the uncured second elastomeric material of the outer layer 16 to the surface of the cord of uncured first elastomeric material may apply pressure which “squeezes” the uncured first elastomeric material radially inward to ensure an intimate contact between the two materials. This pressure may also reduce the cross-sectional diameter of the previously oversized cord of uncured first elastomeric material to match the desired final cross-sectional diameter for the inner core 14 of the radially layered cord 12. In an embodiment, the crosshead extrusion of the uncured second elastomeric material of the outer layer 16 onto the outer surface of the cord of uncured first elastomeric material may reduce the cross-sectional diameter of the cord of uncured first elastomeric material by 0.127 millimeter to 0.381 millimeter.

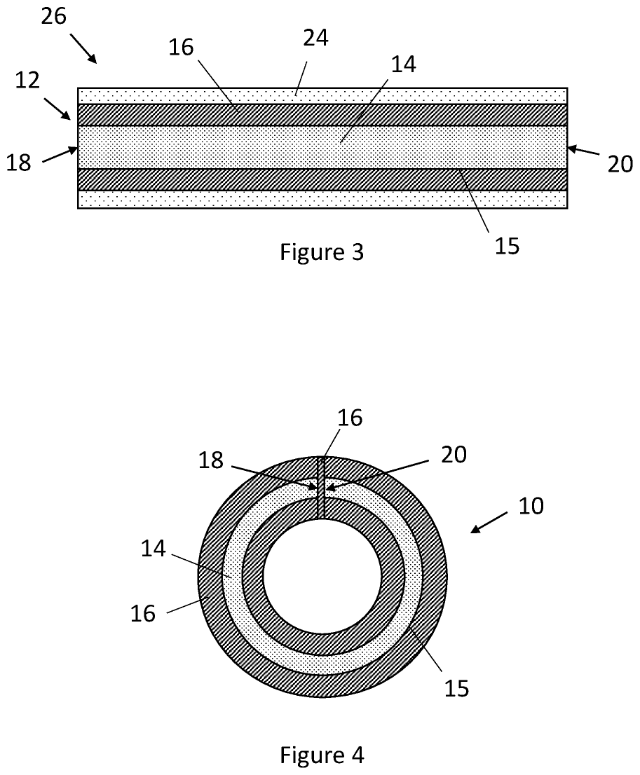

The uncured first elastomeric material of the inner core 14 and the uncured second elastomeric material of the outer layer 16, together forming the uncured radially layered cord 12, are then co-cured and crosslinked at their interface 15. The uncured radially layered cord 12 may first be inserted into a protective sacrificial sleeve 24 to form a curing assembly 26, as depicted in FIG. 3. In an embodiment, the protective sacrificial sleeve 24 may include a pre-cured elastomeric material. This pre-cured protective sacrificial sleeve 24 may protect the outer surface of the uncured radially layered cord 12 and maintain the overall shape of the uncured radially layered cord 12 prior to and during the curing process. The curing assembly 26 may then be heated in an inert atmosphere autoclave for a time and temperature appropriate to sufficiently co-cure the uncured first elastomeric material of the inner core 14 and the uncured second elastomeric material of the outer layer 16. This process vulcanizes the first elastomeric material of the inner core 14 and the second elastomeric material of the outer layer 16 and crosslinks them together at their interface 15. The first elastomeric material of the inner core 14 and the second elastomeric material of the outer layer 16 may be selected to have similar cure chemistries such that a strong and robust crosslinked bond may be formed at their interface 15 during the co-curing process. No adhesives or crosslinking additives are required to bind or crosslink the two materials together before, during or after co-curing. After co-curing, the protective sacrificial sleeve 24 may be removed and disposed of.

In an embodiment, the radially layered cord 12 may be formed to have any desired length or, in an alternative embodiment, may be cut into one or more cord segments having any desired length either before or after the co-curing process. In either embodiment, the radially layered cord 12, or the one or more cord segments, may have a first end 18 and a second end 20. The first end 18 and the second end 20 of the radially layered cord 12 may be spliced together using a hot vulcanization method to form the composite annular seal 10, as depicted in cross-section taken along a radial plane in FIG. 4. A small amount of uncured second elastomeric material of the outer layer 16 may be used to facilitate the splice. Accordingly, the resulting composite annular seal 10 of the present invention may have a cross-sectional (i.e., thickness) diameter ranging from, for example, 1.00 millimeters to 10.00 millimeters, 2.00 millimeters to 9.00 millimeters, 3.00 millimeters to 8.00 millimeters, 4.00 millimeters to 7.00 millimeters, or 5.00 millimeters to 6.00 millimeters. In an embodiment, the resulting composite annular seal 10 may have a cross-sectional diameter of, for example, 5.33 millimeters. The resulting composite annular seal 10 may have an interior diameter (of the space created by the composite annular seal 10) ranging from, for example, 152.4 millimeters to 457.2 millimeters. Although the shape of the radially layered seal 10 is shown for purposes of illustration to be generally circular, such shape alternatively may independently be rectangular, square, elliptical or otherwise regular polygonal or irregular such that it is compatible with the semiconductor process chamber intended to be sealed by the composite annular seal 10. The remaining post processing and cleaning steps are the same as for a typical molded part manufactured for the semiconductor industry.

The resulting composite annular seal 10 of the present invention, having the outer layer 16 made of, for example, FFKM or any other highly thermally and chemically resistant elastomeric material provides a plasma resistance in semiconductor process chamber seals that is conventionally achieved only by homogeneous FFKM annular seals, conventionally manufactured by compression or injection molding. By including the inner core 14 made of less expensive elastomeric material, such as for example FKM, the overall cost of the composite annular seal 10 of the present invention can be significantly reduced while still achieving higher resistance to aggressive thermal and chemical conditions present in semiconductor process chambers. Furthermore, unlike existing co-extrusion processes for plastics and other types of elastomers utilized in the manufacture of hoses and some extruded profiles, such as FKM, nitrile rubber (NBR), and styrene-butadiene rubber (SBR), the co-extrusion process of the present invention may be applied specifically to achieve the UHV and UHP cleanliness levels necessary for semiconductor applications and to produce a continuous non-homogenous elastomeric annular seal 10 that is resistant to plasma and other process gases while maintaining low particle and/or metal contamination.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of manufacturing a composite annular seal for a semiconductor process chamber comprising the steps of:
extruding a first elastomeric material in uncured form to form a cord of uncured first elastomeric material,
extruding, via crosshead extrusion, a second elastomeric material in uncured form onto an outer surface of the cord of uncured first elastomeric material to form an uncured radially layered cord, the uncured radially layered cord comprising an inner core comprising the first elastomeric material and an outer layer comprising the second elastomeric material, wherein the second elastomeric material is different than the first elastomeric material,
co-curing the first elastomeric material and the second elastomeric material of the uncured radially layered cord to form a cured radially layered cord,
splicing a first end of the cured radially layered cord with a second end of the cured radially layered cord to form the composite annular seal.

2. The method of claim 1 wherein the splicing comprises splicing via hot vulcanization.

3. The method of claim 1 wherein the second elastomeric material is more thermally and chemically resistant than the first elastomeric material.

4. The method of claim 1 wherein the first elastomeric material comprises a fluoroelastomer.

5. The method of claim 1 wherein the second elastomeric material comprises a perfluoroelastomer.

6. The method of claim 1 wherein the co-curing further comprises:
inserting the uncured radially layered cord into a protective sacrificial sleeve to form a curing assembly,
heating the curing assembly in an inert atmosphere autoclave for a time and temperature appropriate to sufficiently cure the first elastomeric material and the second elastomeric material of the uncured radially layered cord and crosslink the first elastomeric material and the second elastomeric material at an interface; and
removing the protective sacrificial sleeve.

7. The method of claim 6 wherein the protective sacrificial sleeve comprises a pre-cured elastomeric material.

8. The method of claim 1 wherein the uncured cord of first elastomeric material has a cross-sectional diameter greater than a cross-sectional diameter of the inner core of the uncured radially layered cord.

9. The method of claim 1 wherein the composite annular seal has a cross-sectional diameter ranging from 1.00 millimeters to 10.00 millimeters.

10. The method of claim 1 wherein the composite annular seal has a cross-sectional diameter of 5.33 millimeters.

11. The method of claim 1 wherein the composite annular seal has an interior diameter ranging from 152.4 millimeters to 457.2 millimeters.

12. A composite annular seal manufactured by the method of claim 1.

13. A method of manufacturing a composite annular seal for a semiconductor process chamber comprising the steps of:
extruding a first elastomeric material in uncured form to form a cord of uncured first elastomeric material, wherein the first elastomeric material comprises a fluoroelastomer,
extruding, via crosshead extrusion, a second elastomeric material in uncured form onto an outer surface of the cord of uncured first elastomeric material to form the uncured radially layered cord, the uncured radially layered cord comprising the inner core comprising the first elastomeric material and an outer layer comprising the second elastomeric material, wherein the extruding reduces the diameter of the cord of uncured first elastomeric material by 0.127 millimeter to 0.381 millimeter, and wherein the second elastomeric material comprises a perfluoroelastomer that is more thermally and chemically resistant than the fluoroelastomer of the first elastomeric material,
co-curing the first elastomeric material and the second elastomeric material of the uncured radially layered cord to form a cured radially layered cord, wherein the co-curing comprises:
inserting the uncured radially layered cord into a pre-cured protective sacrificial sleeve to form a curing assembly, and
heating the curing assembly in an inert atmosphere autoclave for a time and temperature appropriate to sufficiently cure the first elastomeric material and the second elastomeric material of the uncured radially layered cord and crosslink the first elastomeric material and the second elastomeric material at an interface, and
removing the protective sacrificial sleeve, and
splicing a first end of the cured radially layered cord with a second end of the cured radially layered cord to form the composite annular seal, wherein the composite annular seal has a cross-sectional diameter of 5.33 millimeters and an interior diameter ranging from 152.4 millimeters to 457.2 millimeters.

14. The method of manufacturing of claim 13 wherein the splicing comprises splicing via hot vulcanization.

15. A composite annular seal manufactured by the method of claim 13.
